(19) United States
(12) Patent Application Publication
(10) Pub. No.: US 2003/0002565 A1
(43) Pub. Date: Jan. 2, 2003

(54) Synchronization algorithm for a direct sequence spread spectrum system with frequency downconversion

(76) Inventor: Juergen Kockmann, Duesseldorf (DE)

Correspondence Address: Siemens Corporation, Attn: Elsa Keller, Legal Administrator, Intellectual Property Department, 186 Wood Avenue South, Iselin, NJ, 08830, US

(21) Appl. No.: 09/754,902

(22) Filed: Jan. 4, 2001

(51) Int. Cl. H04K 1/00

(52) U.S. Cl. 375/145; 375/149; 375/344; 375/354

(57) ABSTRACT

A frequency downconversion receiver is provided that does not require predictive filtering for signal acquisition and synchronization. A sync block modulates a voltage-controlled oscillator (VCO) with twice the frequency of the incoming modulated receive signal. From this, the bit position of the incoming data can be determined. The value of the incoming data can be determined from whether the VCO output and the demodulator output have consecutive predetermined values.

### BACKGROUND OF THE INVENTION

1. Field of the Invention

The present invention relates to telecommunication systems and, particularly, to a system that is more robust against in-band interferers.

2. Description of the Related Art

Typical direct sequence spread spectrum cordless telephone systems use a single conversion radio receiver. Such a receiver is illustrated more particularly in FIG. 1. The system 100 includes an antenna 101, a band-pass filter 102, a mixer 104, a voltage-controlled oscillator 106, a band-pass filter 108, a demodulator 110, a low-pass filter 112, and a synchronization block 114.

A modulated signal is received at the antenna 101 and is band-pass filtered by the band-pass filter 102. The band-pass filter 102 reduces the receiving signal bandwidth to the bandwidth that covers all the used channels. By doing so, the band-pass filter 102 filters out the out-of-band interference. The signal output from the band-pass filter 102 is mixed in the mixer 10 with a lower constant frequency signal which may be generated, as shown, by the voltage controlled oscillator 106. The modulated receive signal is thus transferred down to a lower frequency, typically referred to as the Intermediate Frequency (IF). The band-pass filter 108 is provided behind the mixer 104 because the output of the mixer 104 is two down-converted modulated receive signals on two different frequencies, only one of which can be used in the demodulator 110. Thus, only one of the down-converted IF signals is passed through the band-pass filter 108 to the demodulator 112. The demodulator 110 converts the frequency-modulated signal into a baseband signal, which is low-pass filtered using the low-pass filter 112. Finally, the sync block 114 synchronizes to the low-pass filtered signal.

Such single conversion receivers may be disadvantageous in that a relatively large bandwidth is required for the band pass filter 108. More particularly, the bandwidth of the filter 108 must be at least twice the bandwidth of the system's frequency deviation. Typically, the frequency deviation is +/−f. That is, if a logical 0 is received, the receive frequency is +f. If a logical 1 is received, the receive frequency is −f. The bandpass filter bandwidth must therefore be 2 f.

Because of this relatively high bandwidth, the system is not robust against interferers at the carrier frequency, which can result in low performance against in band interferers. Moreover, the band pass filter is typically implemented as a relatively expensive surface acoustic wave filter.

An alternative to the single conversion receiver is a frequency downconversion receiver, in which the sync block modulates the voltage controlled oscillator. Such receivers are relatively more robust against in band interferers. However, such receivers are disadvantageous in that the sync block must predict the incoming signaling, i.e., implement some kind of predictive filtering, in order to synchronize to it. Often, this can be difficult or impossible.

### SUMMARY OF THE INVENTION

These and other problems in the prior art are overcome in large part by a system and method according to the present invention. A frequency downconversion receiver is provided that does not require predictive filtering for signal acquisition and synchronization. A sync block modulates a voltage-controlled oscillator (VCO) with twice the frequency of the incoming rmodulated receive signal. From this, the bit position of the incoming data can be determined. The value of the incoming data can be determined from whether the VCO output and the demodulator output have consecutive predetermined values.

### BRIEF DESCRIPTION OF THE DRAWINGS

A better understanding of the invention is obtained when the following detailed description is considered in conjunction with the following drawings in which:

FIG. 1 is a diagram illustrating a radiofrequency receiver according to the prior art;

FIG. 2 is a block diagram of an exemplary radiofrequency receiver according to an implementation of the present invention;

FIG. 3 is a diagram of signal timing according to an implementation of the invention;

FIG. 4 is a block diagram of an exemplary synchronization block according to an implementation of the invention; and

FIG. 5 is a flowchart illustrating operation of an implementation of the invention.

### DETAILED DESCRIPTION OF THE INVENTION

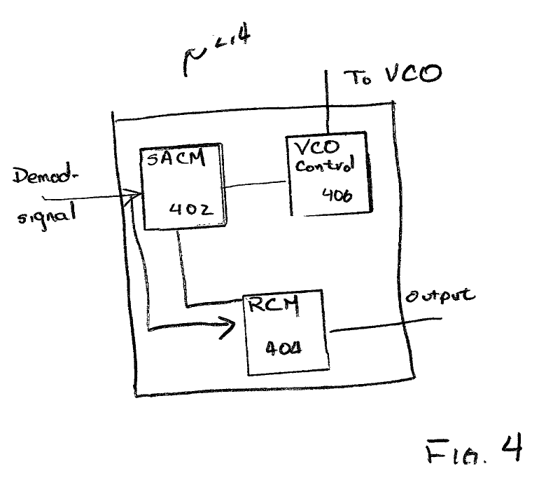

FIGS. 2-5 illustrate a telecommunications system including telecommunications devices according to an implementation of the present invention. A frequency downconversion receiver is provided that does not require predictive filtering for signal acquisition and synchronization. A sync block modulates a voltage-controlled oscillator (VCO) with twice the frequency of the incoming rmodulated receive signal. From this, the bit position of the incoming data can be determined. The value of the incoming data can be determined from whether the VCO output and the demodulator output have consecutive predetermined values.

FIG. 2 is a diagram of an exemplary receiver in accordance with an implementation of the present invention. The receiver 200 includes an antenna 201, a band-pass filter 202, a mixer 204, a voltage-controlled oscillator 206, a low-pass filter 208, a demodulator 210, a low-pass filter 212, and a synchronization block 214.

A modulated signal is received at the antenna 201 and is band-pass filtered by the band-pass filter 202. The band-pass filter 202 reduces the receiving signal bandwidth to the bandwidth that covers only the channel currently in use, responsive to the frequency select signal. By doing so, the band-pass filter 202 filters out the out-of-band interference.

The signal output from the band-pass filter 202 is mixed in the mixer 204 with a lower constant frequency signal which may be generated, as shown, by the voltage controlled oscillator 206. The voltage-controlled oscillator is modulated by the sync block 214, as will be explained in greater detail below.

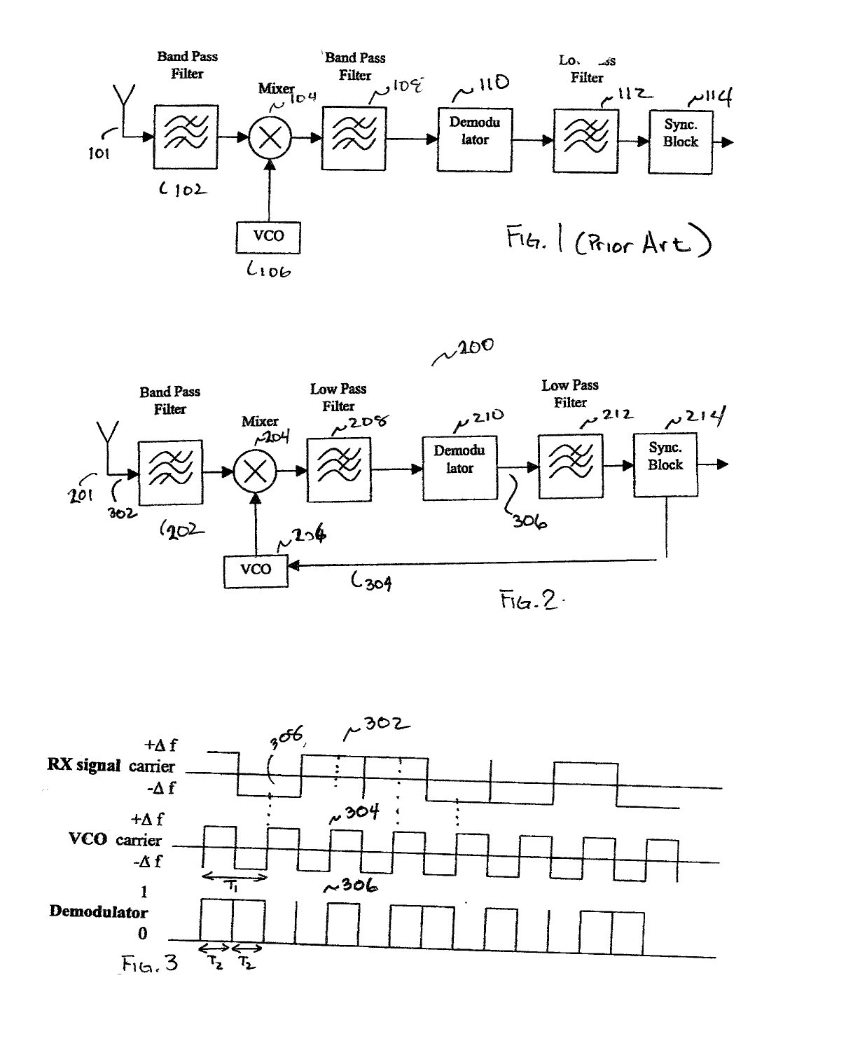

The modulated receive signal is thus transferred down to the Intermediate Frequency (IF). The use of frequency downconversion allows use of a low-pass filter 208 rather than the band pass filter 108 of FIG. 1. Such a low-pass filter is relatively easier and less expensive to implement than the band-pass filter of FIG. 1.

The down-converted IF signal is passed through the low-pass filter 208 to the demodulator 212. The demodulator 210 converts the frequency-modulated signal into a baseband signal, which is low-pass filtered using the low-pass filter 212. Finally, the sync block 214 synchronizes to the low-pass filtered signal.

As will be explained in greater detail below, a receive signal carrier 302 is input to the band pass filter 202; a VCO carrier signal 304 is input to the VCO 206; and a signal 306 is output from the demodulator 210. The sync block 214 reads the output of the demodulator 210 and generates the signal driving the VCO 206. From these, the sync block 214 can determine the receive signal bit positions and values.

FIG. 3 illustrates the relationships between these signals 302, 304, 306. The incoming data 302 on the antenna 201 are modulated digital data with logical levels of 0 and 1, modulated about the carrier frequency by +/−f. The sync block 214 generates an alternating 1-0-1-0 pattern 304, which is used to drive the VCO 206. If this pattern is generated with twice the data rate of the to be received signal 302, then every received bit will be received at a half bit length at the same VCO frequency.

The signal 302 is the incoming receive (RX) signal received at the antenna 201. It is the carrier modulated by +/−f. The signal 304 is the VCO frequency that is driven by the sync block 214. It has twice the bit rate of the receive signal 302 and is modulated around the same carrier by +/−f. The signal 306 is the output of the demodulator 210. If the receive signal 302 and the VCO signal 304 are at the same frequency, then the output of the demodulator 210 is one. If they are on different frequencies, the output is zero.

If the output 306 of the demodulator 210 is the same over two half periods T₂, then the middle of the receive signal bit is at the beginning of the first VCO bit and at the end of the second VCO bit. This information is used to determine the bit position of the receive data stream.

Once the bit position has been determined, the sync block 214 checks to determine if the output of the demodulator 306 was high when the VCO was high. If so, then the incoming receive bit was high. If the demodulator was high at VCO low, then the incoming receive bit was low.

In operation, a receive signal is received, including initially a synchronization pattern. The sync block 214 reads the demodulator 210's output and drives the VCO 206. The sync block then reads the demodulator output to determine if the demodulator output has the same value for two time periods to find the bit position of the incoming signal. Then, the values of the incoming data are determined and output. The sync block 214 thus includes circuitry adapted to read the demodulator signal, adjust the modulation of the VCO 206, e.g., adjusting the delay or relative position of the VCO signal, and compare the demodulator signal with the VCO signal to determine the output signal.

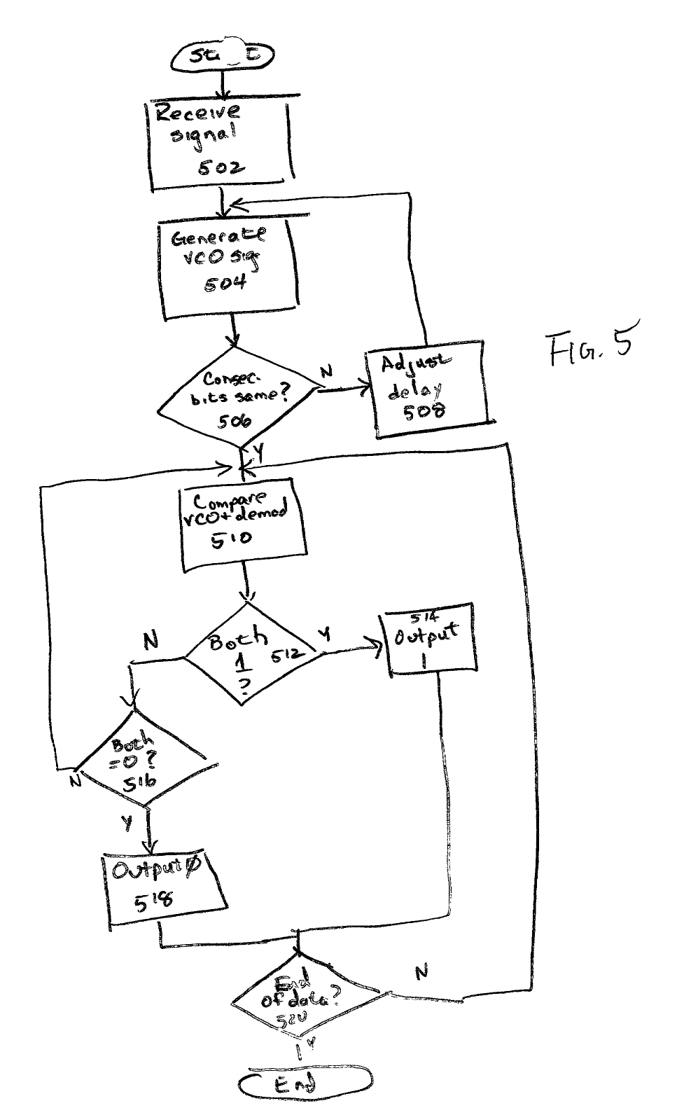

FIG. 4 is a block diagram of the sync block 214. The sync block 214 includes a signal acquisition compare module (SACM) 402, a receive signal compare module (RCM) 404, and a VCO control module 406. The signal acquisition compare module 402 contains circuitry operable to receive the incoming demodulated signal and the values are the same over consecutive time periods. The signal acquisition compare module 402 is further operable to control the output of the VCO control module 406, which adjusts the delay of the VCO signal until the signal acquisition compare module detects consecutive same values. The receive compare module 404 receives both the demodulator output and the VCO carrier. As noted above, if the output of the demodulator 306 was high when the VCO was high, then the incoming receive bit was high. If the demodulator was high at VCO low, then the incoming receive bit was low.

The various components of the sync block 214 may be implemented as one or more application specific integrated circuits (ASICS) or may be implemented as various combinations of executable software code running on one or more on-chip or discrete processors, and associated storage devices, such as random access memory, read only memory, or mass storage such as a magnetic disk drive.

Operation of an implementation of the present invention is illustrated more particularly with reference to the flowchart of FIG. 5. In a step 502, the receiver receives the incoming signal 302 and in step 504, the VCO control generates the VCO control signaling. In a step 506, the signal acquisition compare module 402 reads the demodulated signal to determine if two consecutive bits are the same. If not, then the VCO control module adjusts the delay in step 508. If so, then in step 510, the receive compare module 404 compares the VCO and demodulator signals. If the signals are both 1, as determined in step 512, then in step 514, the receive compare module 404 outputs a 1 for the sync block 214. If not, then the receive compare module 404 determines if the signals are both 0, in step 516. If so, then a 0 is output, in step 518. Otherwise, the system cycles back to compare the signals. Next, in step 520, if the signal stream ends, then the process stops. Otherwise, the system cycles back to step 510 to keep comparing the received, synchronized bits.

It is noted that, while described above with reference to a direct sequence spread spectrum system, the invention is also suited for use in frequency hopping spread spectrum systems, such as those employing the DECT or WDCT standards. The invention described in the above detailed description is not intended to be limited to the specific form set forth herein, but is intended to cover such alternatives, modifications and equivalents as can reasonably be included within the spirit and scope of the appended claims.

What is claimed is:

1. A frequency downconversion receiver for a cordless telephone, comprising:
a bandpass filter for receiving a modulated receive signal;
a mixer for mixing an output of said bandpass filter with an output from a voltage controlled oscillator;
a lowpass filter operably coupled to said mixer;
a demodulator; and
a sync block operably coupled said demodulator and operable to modulate said voltage controlled oscillator at twice a data rate of said modulated receive signal, wherein said sync block is adapted to determine a bit position of said modulated receive signal by determining if an output of a demodulator has a plurality of predetermined consecutive values.

2. A frequency downconversion receiver in accordance with claim 1, wherein said sync block is adapted to determine a value of a bit of said receive signal by comparing a value of an output of said demodulator with a value of said modulated signal.

3. A frequency downconversion receiver in accordance with claim 2, wherein said predetermined consecutive values are consecutive same values

4. A frequency downconversion receiver in accordance with claim 3, further wherein a bit of said receive signal is determined to be high if a value of said modulated signal and an output of said demodulator are both high.

5. A synchronization system, comprising:
means for driving a voltage controlled oscillator with a modulated signal having a frequency twice that of a modulated receive signal; and
means for determining a bit position by determining if an output of a demodulator has a plurality of predetermined consecutive values.

6. A synchronization system in accordance with claim 5, comprising means for subsequently determining a value of a bit of said receive signal by comparing a value of an output of said demodulator with a value of said modulated signal.

7. A synchronization system in accordance with claim 6, wherein said predetermined consecutive values are consecutive same values.

8. A synchronization system in accordance with claim 7, wherein a bit of said receive signal is determined to be high if a value of said modulated signal and an output of said demodulator are both high.

9. A synchronization method for a spread spectrum receiver including a voltage controlled oscillator, a demoulator and a sync block, the modulated signal comprising:
driving the voltage controlled oscillator with a modulated signal generated by the sync block, having a frequency twice that of a modulated receive signal; and
determining a bit position using the synch block by determining if an output signal of the demodulator has a plurality of predetermined consecutive values.

10. A synchronization method in accordance with claim 9, comprising subsequently determining a value of a bit of said receive signal using the synch block by comparing a value of the output signal of said demodulator with a value of said modulated signal.

11. A synchronization method in accordance with claim 10, wherein said predetermined consecutive values are consecutive same values.

12. A synchronization method in accordance with claim 11, wherein a bit of said receive signal is determined to be high if a value of said modulated signal and the output signal of said demodulator are both high.
